(19) United States
(12) Patent Application Publication
(10) Pub. No.: US 2025/0355605 A1
(43) Pub. Date: Nov. 20, 2025

(54) IMAGE FORMING APPARATUS, IMAGE FORMING METHOD, AND COMPUTER-READABLE RECORDING MEDIUM

(71) Applicant: SHARP KABUSHIKI KAISHA, Osaka (JP)

(72) Inventors: KANJI NAKAGAWA, Osaka (JP); Yuki SHIBAYAMA, Osaka (JP)

(21) Appl. No.: 19/206,791

(22) Filed: May 13, 2025

(30) Foreign Application Priority Data
May 20, 2024 (JP) 2024-081374

(51) Int. Cl. G06F 3/12

(52) U.S. Cl. CPC G06F 3/1273; G06F 3/1205; G06F 3/1238; G06F 3/1242

(57) ABSTRACT

There is provided an image forming apparatus including an acquisition unit that acquires print data, and one or more controllers that execute storing a print job added with the print data, wherein the one or more controllers execute adding, to an image based on the print data, an image based on tracking information selected by an operation of a user from tracking information related to the storing of the print job and tracking information related to executing the print job and then executes printing the images.

### CROSS-REFERENCE TO RELATED APPLICATION

The present application claims priority from Japanese Application JP 2024-081374, filed on May 20, 2024, the content of which is hereby incorporated by reference into this application.

### BACKGROUND

### 1. Field

The disclosure relates to an image forming apparatus, an image forming method, and a computer-readable recording medium.

### 2. Description of the Related Art

The related art discloses a technique for printing, on a medium, a code image including information related to printing time, information related to a person who has requested the printing, and the like and a document image.

### SUMMARY

When a generated print job is immediately executed, tracking information in printing (a user who has requested the executing of printing, a date and time of the printing, and the like) may be simply added as a code image and the like. On the other hand, when a print job is temporarily stored in an image forming apparatus to be executed later (by the same user as or a different user from a user who has requested storing the print job), depending on the intended usage of a print result, it may be appropriate to add tracking information related to the storing of the print job (the user who has requested the storing of the print job, a date and time of the storing, and the like) or tracking information related to the executing of the print job (the user who has requested the executing of the print job, the date and time of the printing, and the like). In the technique disclosed in the related art, only information related to the printing is added to an image based on print data included in the print job and then, the image is printed. Thus, in the technique disclosed in the related art, it is not possible to print the image with information corresponding to the intended usage of the print result added to the image based on the print data. Accordingly, one aspect of the disclosure is to provide an image forming apparatus, an image forming method, and a computer-readable recording medium that are capable of adding information corresponding to an intended usage of a print result to an image based on print data and then printing the image.

According to an embodiment of the disclosure, there is provided an image forming apparatus including an acquisition unit that acquires print data, and one or more controllers that execute storing a print job added with the print data, wherein the one or more controllers execute adding, to an image based on the print data, an image based on tracking information selected by an operation of a user from tracking information related to the storing of the print job and tracking information related to executing the print job and then executes printing the images.

According to an embodiment of the disclosure, there is provided an image forming method including acquiring print data, storing a print job added with the print data, and adding, to an image based on the print data, an image based on tracking information selected by an operation of a user from tracking information related to the storing of the print job and tracking information related to executing the print job and then printing the images.

According to an embodiment of the disclosure, there is provided a computer-readable recording medium that records a program, the program causing a computer to execute adding, to a print job, print data and tracking information selected by an operation of a user from tracking information related to storing the print job and tracking information related to executing the print job, and transmitting the print job to an image forming apparatus.

According to an aspect of the disclosure, it is possible to provide an image forming apparatus, an image forming method, and a computer-readable recording medium that are capable of adding information corresponding to an intended usage of a print result to an image based on print data and then printing the image.

### BRIEF DESCRIPTION OF THE DRAWINGS

FIG. 1 is a block diagram illustrating an example of an overall configuration of a printing system.

FIG. 2 is a diagram illustrating an example of print jobs according to a first embodiment.

FIG. 3 is a block diagram illustrating an example of a configuration of a terminal device.

FIG. 4 is a block diagram illustrating an example of a configuration of an image forming apparatus.

FIG. 5 is a flowchart illustrating an example of an operation of the terminal device according to the first embodiment.

FIG. 6 is a diagram illustrating an example of a print settings screen displayed on a display of the terminal device according to the first embodiment.

FIG. 7 is a flowchart illustrating an example of an operation of the image forming apparatus when the terminal device transmits a print job to the image forming apparatus.

FIG. 8 is a flowchart illustrating an example of an operation of the image forming apparatus when the image forming apparatus acquires print data by reading a document placed on a document table or loading print data stored in an external recording medium.

FIG. 9 is a flowchart illustrating an example of an operation of the image forming apparatus, following FIG. 8.

FIG. 10 is a diagram illustrating an example of a data selection screen.

FIG. 11 is a diagram illustrating an example of the print settings screen displayed on the display of the image forming apparatus according to the first embodiment.

FIG. 12 is a diagram illustrating an example of print jobs according to a second embodiment.

FIG. 13 is a diagram illustrating an example of a print settings screen displayed on a display of a terminal device according to the second embodiment.

FIG. 14 is a diagram illustrating an example of a system settings screen displayed on the display of the terminal device according to the second embodiment.

FIG. 15 is a diagram illustrating an example of a detailed settings screen of tracking information.

FIG. 16 is a flowchart illustrating an example of an operation of the terminal device according to the second embodiment.

FIG. 17 is a flowchart illustrating an example of an operation of an image forming apparatus according to the second embodiment.

FIG. 18 is a diagram illustrating an example of a system settings screen displayed on a display of a terminal device according to a third embodiment.

FIG. 19 is a diagram illustrating an example of a tracking contents selection screen displayed on a display of an image forming apparatus according to the third embodiment.

### DETAILED DESCRIPTION OF THE DISCLOSURE

### First Embodiment

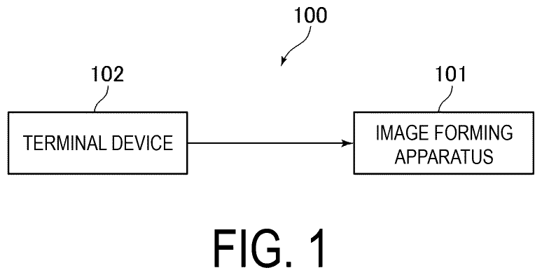

A first embodiment will be described with reference to FIG. 1 to FIG. 11. In the drawings, the same or equivalent elements are denoted by the same reference signs, and redundant descriptions will be omitted.

FIG. 1 is a diagram illustrating one example of an overall configuration of a printing system 100. The printing system 100 includes an image forming apparatus 101 and a terminal device 102.

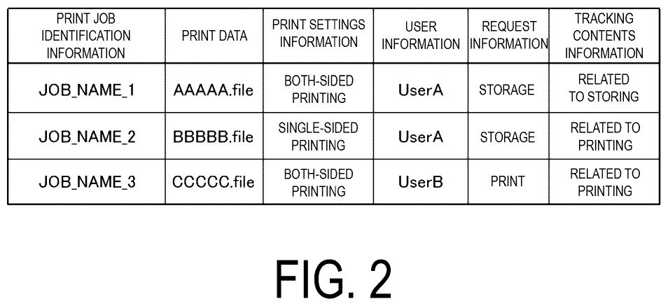

The image forming apparatus 101 is capable of storing a print job (see FIG. 2) and executes the print job. When execution of a print job is requested, the image forming apparatus 101 adds, to an image based on print data added to the print job, an image based on tracking information selected by an operation of a user from tracking information related to storing the print job and tracking information related to executing the print job and then, prints the images.

The terminal device 102 is communicable with the image forming apparatus 101, and is an information processing apparatus that is operated by a user. The terminal device 102 is connected to the image forming apparatus 101 through a wired or wireless network. Examples of the network between the terminal device 102 and the image forming apparatus 101 include the Internet and a Local Area Network (LAN). Examples of the terminal device 102 include a smartphone, a laptop Personal Computer (PC), a tablet terminal, and a desktop PC. The terminal device 102 transmits a print job to the image forming apparatus 101.

FIG. 2 is a diagram illustrating one example of print jobs according to the present embodiment. Print job identification information, print data, print settings information, user information, request information, and tracking contents information are added to the print job illustrated in FIG. 2 as an example. The print job identification information includes a unique character string and a unique number that are assigned to each print job and the like. The print data indicates image data, data in a page description language format, and the like. The print settings information indicates setting details related to executing printing. For example, the print settings information indicates single-sided printing, both-sided printing, or the like. The user information indicates a user name of a user. For example, the user is a user of the terminal device 102 that serves as the transmission source of the print job. The request information indicates a request for the print job in the image forming apparatus 101. For example, the request indicated by the request information indicates a request for storing the print job in the image forming apparatus 101 or a request for printing the print job without storing the print job in the image forming apparatus 101. The tracking contents information indicates contents of tracking information added to an image based on print data.

For example, a print job including print job identification information of JOB_NAME_1 indicates that print data is data having a file name of AAAAA.file. Both-sided printing is set for the print job having the print job identification information of JOB_NAME_1, and a user name is UserA. Further, the print job having the print job identification information of JOB_NAME_1 is stored in the image forming apparatus 101. Furthermore, the print job having the print job identification information of JOB_NAME_1 indicates that an image or characters indicating information related to storing and an image based on print data are to be printed on a sheet.

In addition, for example, a print job having print job identification information of JOB_NAME_2 indicates that print data is data having a file name of BBBBB.file. The print job having the print job identification information of JOB_NAME_2 is stored in the image forming apparatus 101. Further, the print job having the print job identification information of JOB_NAME_2 indicates that an image or characters indicating information related to printing and an image based on print data are to be printed.

In addition, a print job having print job identification information of JOB_NAME_3 indicates that print data is data having a file name of CCCCC.file. The print job having the print job identification information of JOB_NAME_3 is to be printed without being stored in the image forming apparatus 101. Further, the print job having the print job identification information of JOB_NAME_3 indicates that an image or characters indicating information related to printing and an image based on print data are to be printed.

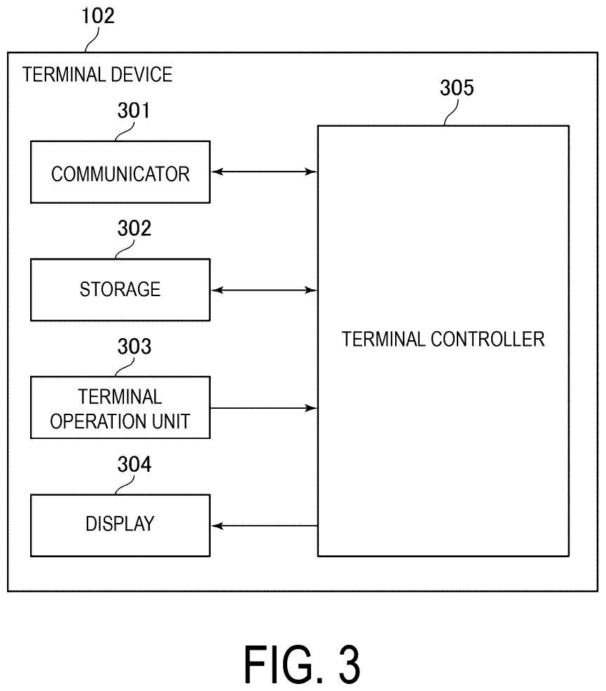

FIG. 3 is a block diagram illustrating one example of a configuration of the terminal device 102. The terminal device 102 includes a communicator 301, a storage 302, a terminal operation unit 303, a display 304, and a terminal controller 305.

The communicator 301 is an interface for connection to the network.

The storage 302 is a storage medium that can store various types of data, programs and the like. For example, the storage 302 is constituted by a Hard Disk Drive (HDD), a Solid State Drive (SSD), a semiconductor memory, or the like.

The terminal operation unit 303 receives an operation by a user. For example, the terminal operation unit 303 is constituted by a touch panel, or the like. The display 304 displays information provided to the user. For example, the display 304 is constituted by a liquid crystal panel, an organic Electro-Luminescence (EL) panel, or the like. Note that a touch panel display in which the terminal operation unit 303 and the display 304 are integrated may be used.

The terminal controller 305 executes various types of processing in accordance with a program stored in the storage 302. For example, the terminal controller 305 includes a processor such as a Central Processing Unit (CPU).

The terminal controller 305 executes transmitting the print job added with the print data to the image forming apparatus 101. Specifically, the terminal controller 305 executes adding, to the print job, tracking contents information indicating contents selected by the operation of the user with respect to the tracking information and then, transmitting the print job to the image forming apparatus 101.

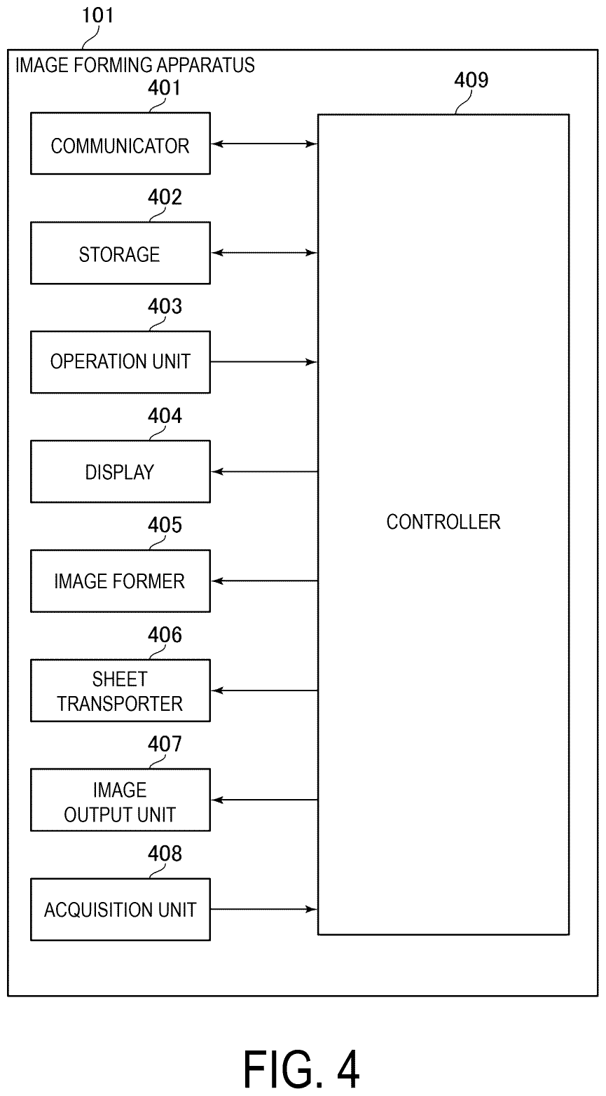

FIG. 4 is a block diagram illustrating one example of a configuration of the image forming apparatus 101. The image forming apparatus 101 includes a communicator 401, a storage 402, an operation unit 403, a display 404, an image former 405, a sheet transporter 406, an image output unit 407, an acquisition unit 408, and a controller 409.

The communicator 401 is an interface for connection to the network.

The storage 402 is a storage medium that can store various types of data, programs and the like. For example, the storage 402 is constituted by a Hard Disk Drive (HDD), a Solid State Drive (SSD), a semiconductor memory, or the like. The storage 402 stores a print job added with print data acquired by the acquisition unit 408.

The operation unit 403 receives an operation by a user. For example, the operation unit 403 is constituted by a touch panel, or the like. The display 404 displays information to be provided to the user. For example, the display 404 is constituted by a liquid crystal panel, an organic Electro-Luminescence (EL) panel, or the like. Note that a touch panel display in which the operation unit 403 and the display 404 are integrated may be used.

The image former 405 forms, on a sheet, an image based on the print data added to the print job. Specifically, the image former 405 attaches a coloring material to a sheet to form an image based on the print data on the sheet. For example, the image former 405 can be constituted by a laser printer of an electrophotographic type or an inkjet printer of an inkjet type. When being constituted by a laser printer, the image former 405 attaches a toner serving as a coloring material to a sheet to form an image on the sheet. In addition, when being constituted by an inkjet printer, the image former 405 attaches an ink serving as a coloring material to a sheet to form an image on the sheet.

The sheet transporter 406 transports the sheet formed with the image by the image former 405. The sheet transporter 406 includes a roller that is used for transporting the sheet.

The image output unit 407 outputs, from a sheet discharge port (not illustrated), the sheet formed with the image by the image former 405.

The acquisition unit 408 acquires print data. For example, the acquisition unit 408 receives a print job transmitted from the terminal device 102 to acquire print data added to the print job. Alternatively, the acquisition unit 408 may read a document placed on a document table (not illustrated) to acquire print data indicating the read document. In this case, the acquisition unit 408 generates the print job added with the generated print data. Alternatively, the acquisition unit 408 may acquire print data by loading the print data stored in an external recording medium. In this case, the acquisition unit 408 generates a print job added with the acquired print data.

The controller 409 executes various types of processing in accordance with a program stored in the storage 402. For example, the controller 409 includes a processor such as a Central Processing Unit (CPU).

The controller 409 executes storing the print job added with the print data. The controller 409 executes storing the print job added with the print data and thus stores the print job in the storage 402. Further, the controller 409 executes adding, to an image based on the print data, an image based on tracking information selected by an operation of a user from tracking information related to storing the print job and tracking information related to executing the print job and then executes printing the images. The tracking information related to storing the print job indicates at least one of a person who has stored the print job and a date and time of the storing. Additionally, the tracking information related to executing the print job indicates at least one of a person who has requested printing and a date and time of the printing.

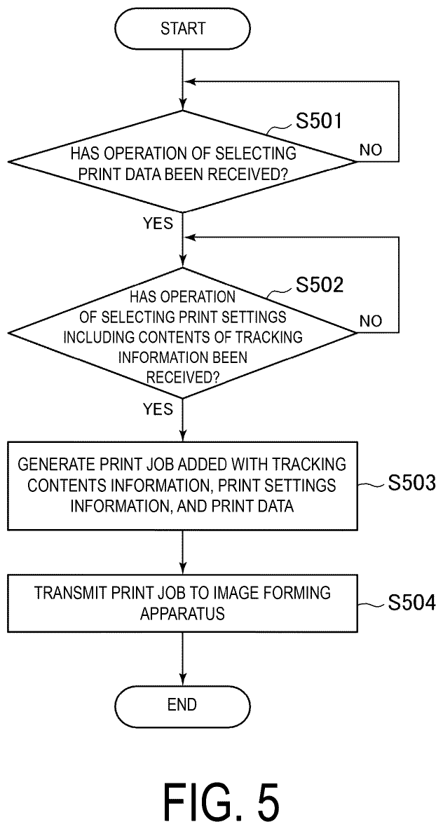

FIG. 5 is a flowchart illustrating an example of an operation of the terminal device 102.

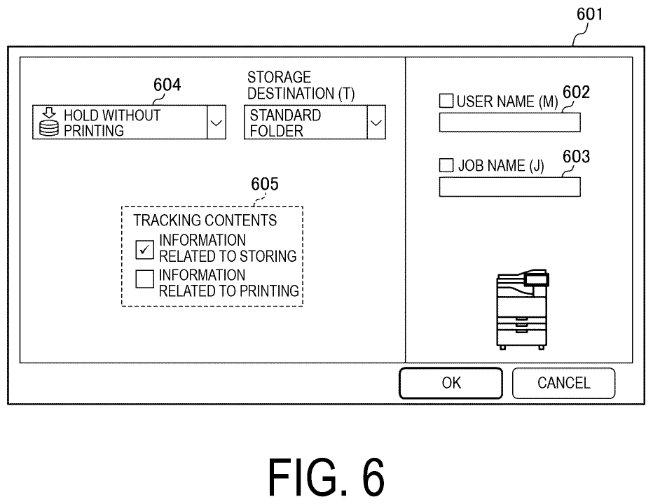

In step S501, the terminal controller 305 determines whether the terminal operation unit 303 has received an operation of selecting print data. When it is not determined in step S501 that the terminal operation unit 303 has received the operation of selecting print data (NO in step S501), the terminal controller 305 returns the processing to step S501. On the other hand, when it is determined in step S501 that the terminal operation unit 303 has received the operation of selecting print data (YES in step S501), the terminal controller 305 determines in step S502 whether the terminal operation unit 303 has received an operation of selecting print settings including contents of tracking information. For example, the terminal controller 305 determines whether the terminal operation unit 303 has received an operation of selecting contents of tracking information, print settings information, and request information, and an operation of inputting print job identification information and user information, on a print settings screen 601 (see FIG. 6).

When it is not determined in step S502 that the terminal operation unit 303 has received the operation of selecting print settings including contents of tracking information (NO in step S502), the terminal controller 305 returns the processing to step S502. On the other hand, when it is determined in step S502 that the terminal operation unit 303 has received the operation of selecting print settings including contents of tracking information (YES in step S502), in step S503, the terminal controller 305 generates a print job added with the print job identification information input by the operation received in step S502, the print data selected by the operation received in step S501, the print settings information selected by the operation received in step S502, the request information selected by the operation received in step S502, the user information input by the operation received in step S502, and the tracking contents information indicating the contents selected by the operation received in step S502.

In step S504, the terminal controller 305 executes transmitting the generated print job to the image forming apparatus 101.

FIG. 6 is a diagram illustrating an example of the print settings screen 601 displayed on the display 304. The print settings screen 601 includes an input area 602 for a user name, an input area 603 for print job identification information (a job name), a settings area 604 for request information, and a settings area 605 for contents of tracking information. The input area 602 is an area where an operation of inputting the user name is to be performed. The input area 603 is an area in which an operation of inputting a character string, a number, or the like indicated by the print job identification information is to be performed.

The settings area 604 is an area in which an operation of selecting whether to store the print job in the image forming apparatus 101 is to be performed. For example, “Hold without printing” denoted in the settings area 604 exemplified in FIG. 6 indicates the fact that storing the print job without printing the image based on the print data added to the acquired print job after the image forming apparatus 101 acquires the print job has been selected.

The settings area 605 is an area in which an operation of selecting contents of tracking information is to be performed. For example, the settings area 605 exemplified in FIG. 6 indicates that tracking contents information indicating contents related to storing the print job are added to the print job. When the terminal operation unit 303 receives an operation on the print settings screen 601, the terminal device 102 can allow the user of the terminal device 102 to select the contents of the tracking information to be added to the print job. That is, the terminal device 102 can allow the user of the terminal device 102 to select whether to add, to the print job, tracking information related to storing or tracking information related to printing.

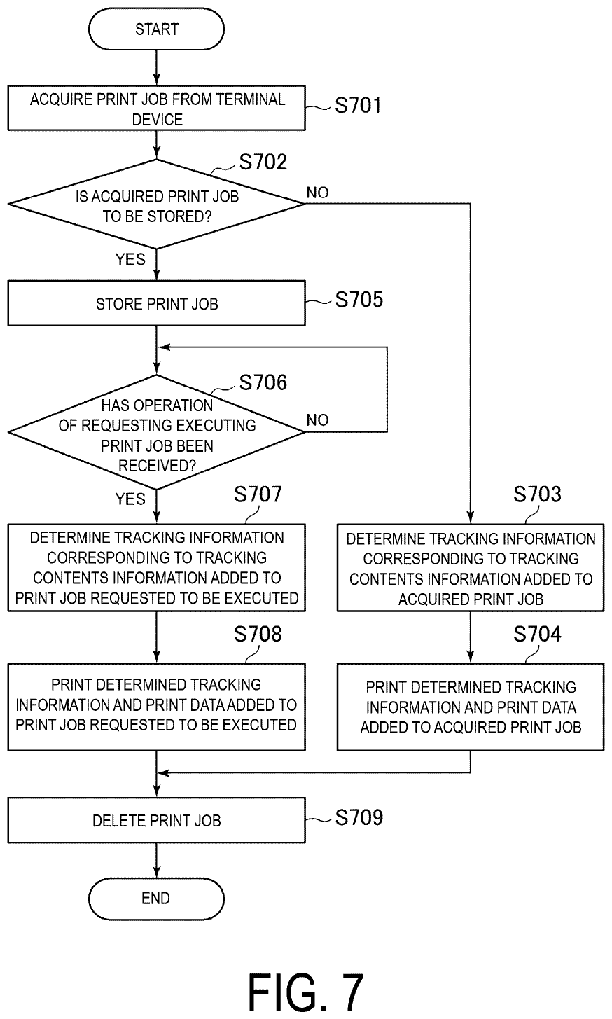

FIG. 7 is a flowchart illustrating an example of an operation of the image forming apparatus 101 when the terminal device 102 transmits a print job to the image forming apparatus 101.

In step S701, the acquisition unit 408 acquires the print job transmitted in step S504 exemplified in FIG. 5. Thus, the acquisition unit 408 acquires the print data added to the print job.

In step S702, the controller 409 determines whether to store the print job. Specifically, when the request information added to the print job indicates a request to store the print job in the image forming apparatus 101, the controller 409 determines to store the print job. On the other hand, when the request information added to the print job indicates a request to execute printing without storing the print job in the image forming apparatus 101, the controller 409 determines that the print job is not to be stored.

When it is determined in step S702 that the print job is not to be stored (NO in step S702), in step S703, the controller 409 determines tracking information corresponding to the tracking contents information added to the print job and adds the tracking information to the print job.

In step S704, the controller 409 executes printing an image based on the tracking information determined in step S703 and the image based on the print data added to the print job. Specifically, the controller 409 allows the image former 405 to form, on a sheet, the image based on the tracking information and the image based on the print data by executing printing the image based on the tracking information and the image based on the print data. The image based on the tracking information indicates at least one of an image or characters. For example, the image based on the tracking information is a coded image. For example, the coded image is a QR code (trade name).

For example, the controller 409 causes the image former 405 to form the image based on the tracking information at a position outside the frame of the image based on the print data within the sheet. Alternatively, the controller 409 may cause the image former 405 to form the image based on the tracking information as a watermark so as to be superimposed on the image based on the print data within the sheet. Then, the controller 409 causes the image output unit 407 to output the sheet formed with the image based on the tracking information and the image based on the print data. After that, in step S709, the controller 409 deletes the print job.

On the other hand, when it is determined that the print job is to be stored in step S702 (YES in step S702), the controller 409 stores the print job in the storage 402 by executing storing the print job in step S705.

In step S706, the controller 409 determines whether the operation unit 403 receives an operation of requesting executing the print job.

Note that before the controller 409 executes the process of step S706, the controller 409 may execute authenticating a user of the image forming apparatus 101. For example, when the operation unit 403 receives an operation of inputting a user name and a password, the controller 409 authenticates the user by knowledge-based authentication using the input user name and the input password. Alternatively, the controller 409 may authenticate the user by possession-based authentication using a possession (such as an IC card, or a smartphone) of the user. Alternatively, the controller 409 may authenticate the user by biometric authentication using biometric information (such as a fingerprint, voice, or face) of the user. Then, when it is determined that the user of the image forming apparatus 101 is successfully authenticated, the controller 409 enables the operation unit 403 to receive an operation of requesting executing the print job.

When it is not determined in step S706 that the operation unit 403 has received the operation of requesting executing the print job (NO in step S702), the controller 409 returns the processing to step S706. On the other hand, when it is determined in step S706 that the operation unit 403 has received the operation of requesting executing the print job (YES in step S706), in step S707, the controller 409 determines tracking information corresponding to the tracking contents information added to the print job and adds the tracking information to the print job.

When the tracking contents information added to the print job indicates contents related to storing the print job, the tracking information determined in step S707 indicates at least one of the user name indicated by the user information added to the print job and the date and time when the print job has been acquired in step S701. That is, the tracking information related to storing the print job indicates at least one of the person who has stored the print job and the date and time of the storing.

On the other hand, when the tracking contents information added to the print job indicates contents of the print job related to printing, the tracking information determined in step S707 indicates the date and time when the operation unit 403 has received the operation of requesting executing the print job in step S706. Further, before executing the process of step S706, when the controller 409 successfully authenticates the user of the image forming apparatus 101 and the tracking contents information added to the print job indicates the contents of the print job related to printing, the tracking information determined in step S707 further indicates the user name of the authenticated user. That is, the tracking information related to printing the print job indicates at least one of the person who has requested the printing and the date and time of the printing.

In step S708, the controller 409 executes printing the image based on the determined tracking information and the image based on the print data added to the print job requested to be executed. The process of step S708 is similar to the process of step S704, and thus, detailed description thereof will be omitted. Since the terminal device 102 can enable the user of the terminal device 102 to select addition of information related to storing or addition of information related to printing, the image forming apparatus 101 according to the present embodiment can print an image based on print data with the added tracking information indicating the contents selected by the user according to an intended usage of a print result. After that, in step S709, the controller 409 deletes the print job.

After the controller 409 stores the print job transmitted from the terminal device 102 by the processing from step S705 to step S708, the user operates the operation unit 403 and thus, the controller 409 executes the print job. Then, the user who has performed the operation of requesting executing the print job acquires the printed sheet. Thus, when the terminal device 102 transmits the print job to the image forming apparatus 101, the image forming apparatus 101 according to the present embodiment can prevent a third party from seeing the printed sheet and prevent a third party from taking away the printed sheet accidentally or intentionally.

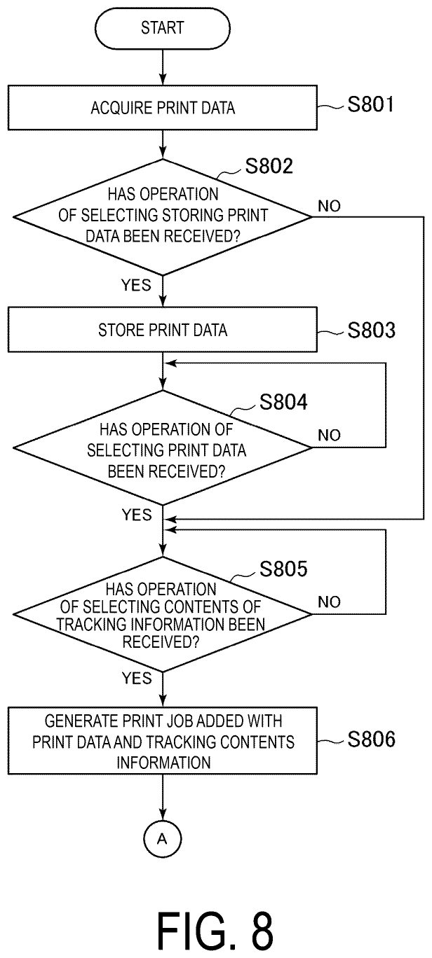

FIG. 8 is a flowchart illustrating an example of an operation of the image forming apparatus 101 when the acquisition unit 408 acquires print data by reading a document placed on a document table or loading print data stored in an external recording medium.

In step S801, the acquisition unit 408 acquires print data. For example, the acquisition unit 408 reads a document placed on a document table (not illustrated) and acquires print data indicating the read document. Alternatively, the acquisition unit 408 acquires print data by loading the print data stored in an external recording medium. Examples of the external recording medium include a Universal Serial Bus (USB) memory.

Note that before the acquisition unit 408 executes the process of step S801, the controller 409 may execute authenticating the user of the image forming apparatus 101. For example, before the acquisition unit 408 executes the process of step S801, the controller 409 executes authenticating the user by knowledge-based authentication, possession-based authentication, biometric authentication, or the like. When it is determined that the user of the image forming apparatus 101 is successfully authenticated, the controller 409 enables the acquisition unit 408 to read a document placed on the document table (not illustrated) and to load print data stored in the external recording medium.

In step S802, the controller 409 determines whether the operation unit 403 has received an operation of selecting storing the print data. When it is not determined in step S802 that the operation unit 403 has received the operation of selecting storing the print data (NO in step S802), the controller 409 shifts the processing to step S805. On the other hand, when it is determined in step S802 that the operation unit 403 has received the operation of selecting storing the print data (YES in step S802), in step S803, the controller 409 stores the print data in the storage 402 by executing storing the print data acquired in step S801.

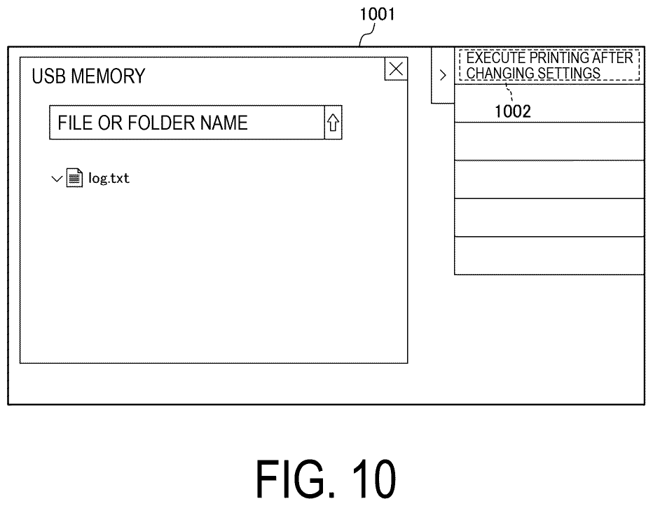

In step S804, the controller 409 determines whether the operation unit 403 has received an operation of selecting the print data to be printed. To be more specific, when the operation unit 403 receives an operation of displaying a data selection screen 1001 (see FIG. 10) after the controller 409 stores the print data in the storage 402 in step S803, the controller 409 displays the data selection screen 1001 on the display 404. Then, the controller 409 determines whether the operation unit 403 has received the operation of selecting the print data to be printed on the data selection screen 1001.

Note that before the controller 409 executes the process of step S804, the controller 409 may execute authenticating the user of the image forming apparatus 101. For example, before the controller 409 executes the process of step S804, the controller 409 executes authenticating the user by knowledge-based authentication, possession-based authentication, biometric authentication, or the like. When it is determined that the user of the image forming apparatus 101 is successfully authenticated, the controller 409 enables the operation unit 403 to receive the operation of selecting the print data to be printed on the data selection screen 1001.

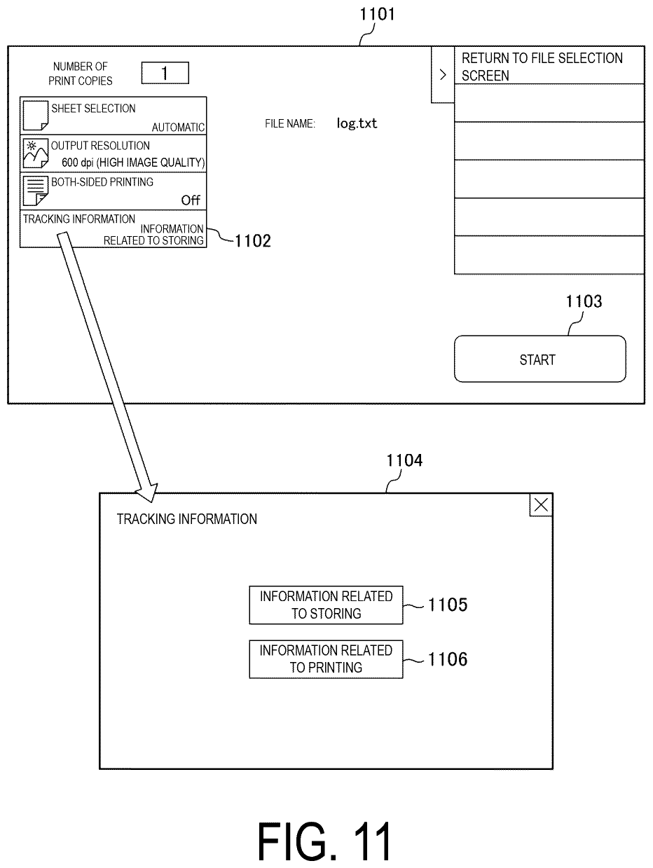

On the other hand, when it is not determined in step S804 that the operation unit 403 has received the operation of selecting the print data to be printed (NO in step S804), the controller 409 returns the processing to step S804. On the other hand, when it is determined in step S804 that the operation unit 403 has received the operation of selecting the print data to be printed (YES in step S804), the controller 409 determines in step S805 whether the operation unit 403 has received an operation of selecting contents of tracking information. Specifically, when the operation unit 403 receives an operation of displaying a print settings screen 1101 (see FIG. 11) on the data selection screen 1001, the controller 409 causes the display unit 404 to display the print settings screen 1101. When the operation unit 403 receives the operation of displaying a tracking contents selection screen 1104 (see FIG. 11) on the print settings screen 1101, the controller 409 causes the display 404 to display the tracking contents selection screen 1104. The tracking contents selection screen 1104 is a screen that allows the user to select contents of tracking information. For example, the controller 409 determines whether the operation unit 403 has received the operation of displaying the tracking contents selection screen 1104 on the print settings screen 1101.

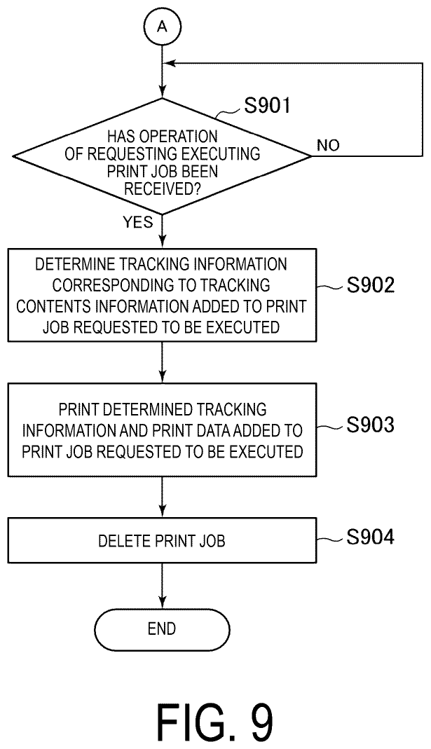

When it is not determined in step S805 that the operation unit 403 has received the operation of selecting contents of tracking information (NO in step S805), the controller 409 returns the processing to step S805. On the other hand, when it is determined in step S805 that the operation unit 403 has received the operation of selecting contents of tracking information (YES in step S805), in step S806, the controller 409 generates a print job added with the print data selected by the operation received in step S804 and the tracking contents information indicating the contents selected by the operation received in step S805. Then, the controller 409 proceeds the processing to step S901 illustrated in FIG. 9 as an example.

Note that the tracking information selected by the operation of the user may be stored for each user. Specifically, when the operation unit 403 receives an operation of selecting tracking contents to determine tracking contents information after successfully authenticating the user of the image forming apparatus 101, the controller 409 may store the determined tracking contents information in the storage 402 in association with user information indicating the authenticated user. Then, it is assumed that after the acquisition unit 408 acquires a new print data in step S801 and before the controller 409 executes the process of step S804, authenticating the user of the image forming apparatus 101 is successfully executed. In this case, in step S806, the controller 409 may generate a print job added with the print data selected by the operation received in step S804 and the tracking contents information associated with the user information indicating the authenticated user. Thus, the image forming apparatus 101 according to the present embodiment can add the tracking contents information indicating the contents of the item designated by the user in the past to the print job for each user. As a result, the image forming apparatus 101 can prevent the user from repeatedly performing the operation of selecting the contents of the tracking information, and can improve user convenience.

FIG. 9 is a flowchart illustrating one example of an operation of the image forming apparatus 101, following FIG. 8.

In step S901, the controller 409 determines whether the operation unit 403 has received an operation of requesting executing the print job. When it is not determined in step S901 that the operation unit 403 has received the operation of requesting executing the print job (NO in step S901), the controller 409 returns the processing to step S901. On the other hand, when it is determined in step S901 that the operation unit 403 has received the operation of requesting executing the print job (YES in step S901), in step S902, the controller 409 determines tracking information corresponding to the tracking contents information added to the print job and adds the tracking information to the print job.

When the tracking contents information added to the print job indicates contents related to storing the print job, the tracking information determined in step S902 indicates the date and time when the print job has been stored in the storage 402 in step S803. Further, when the controller 409 successfully authenticates the user of the image forming apparatus 101 before the acquisition unit 408 executes the process of step S801, the tracking information determined in step S902 further indicates the user name of the authenticated user.

On the other hand, when the tracking contents information added to the print job indicates contents related to printing the print job, the tracking information determined in step S902 indicates the date and time when the operation unit 403 has received the operation of requesting executing the print job in step S901. Furthermore, when the controller 409 successfully authenticates the user of the image forming apparatus 101 before the acquisition unit 408 executes the process of step S804 exemplified in FIG. 8, the tracking information determined in step S902 further indicates the user name of the authenticated user.

In step S903, the controller 409 executes printing an image based on the tracking information determined in step S902 and an image based on the print data added to the print job. The process of step S903 is similar to the process of step S704, and thus, detailed description thereof will be omitted. Then, in step S904, the controller 409 deletes the print job.

FIG. 10 is a diagram illustrating one example of the data selection screen 1001. The data selection screen 1001 indicates that print data having a file name of log.txt has been selected. Further, the data selection screen 1001 includes a button (print settings button) 1002 for changing settings and then executing printing. An operation of selecting the print settings button 1002 is an operation of requesting displaying the print settings screen 1101. When the operation unit 403 receives the operation of selecting the print settings button 1002, the controller 409 causes the display 404 to display the print settings screen 1101.

FIG. 11 is a diagram illustrating an example of the print settings screen 1101 displayed on the display 404. The print settings screen 1101 indicates a settings screen for printing the print data having the file name of log.txt. For example, the print settings screen 1101 exemplified in FIG. 11 indicates settings related to sheet selection, output resolution, and both-sided printing. Further, the print settings screen 1101 includes a tracking information button 1102 and a start button 1103. An operation of selecting the tracking information button 1102 is an operation of requesting displaying the tracking contents selection screen 1104. When the operation unit 403 receives an operation of selecting the tracking information button 1102, the controller 409 causes the display 404 to display the tracking contents selection screen 1104.

The tracking contents selection screen 1104 includes an information selection button 1105 related to storing and an information selection button 1106 related to printing. When the operation unit 403 receives an operation of selecting the information selection button 1105 related to storing, the controller 409 determines tracking contents information indicating contents related to storing in a case where the print job added with the print data having the file name of log.txt is stored. On the other hand, when the operation unit 403 receives an operation of selecting the information selection button 1106 related to printing, the controller 409 determines tracking contents information indicating contents related to printing the print job added with the print data having the file name log.txt. Then, the controller 409 adds the determined tracking contents information to the print job. When the operation unit 403 receives an operation of selecting the start button 1103, the controller 409 executes the print job.

As described above, the image forming apparatus 101 according to the present embodiment can add information matching the intended usage of a print result designated by the user to the image based on the print data and then print the image.

### Modification

As a modification of the printing system 100 according to the present embodiment, in a case where the image forming apparatus 101 executes a print job again, when the print job is associated with information indicating the presence of a print execution history, tracking information selected by an operation of a user in the last execution of the print job may be added and printed. Specifically, when the print job is executed, the controller 409 according to the present modification can store, in the storage 402, the print job in association with the presence or absence of the print execution history, and when the print job is executed again, the controller 409 determines whether the print job is associated with the presence or absence of the print execution history. When it is determined that the print job is in association with information indicating the “presence” of the print execution history, the controller 409 executes printing the image based on print data added with the image based on the tracking information selected by the operation of the user in the last execution of the print job. As a result, in the printing system 100 according to the present modification, when the image forming apparatus 101 executes the print job again, it is possible to prevent the user from repeatedly performing the operation of selecting the contents of the tracking information and to unify the contents of the tracking information for each print job, thereby improving user convenience.

### Second Embodiment

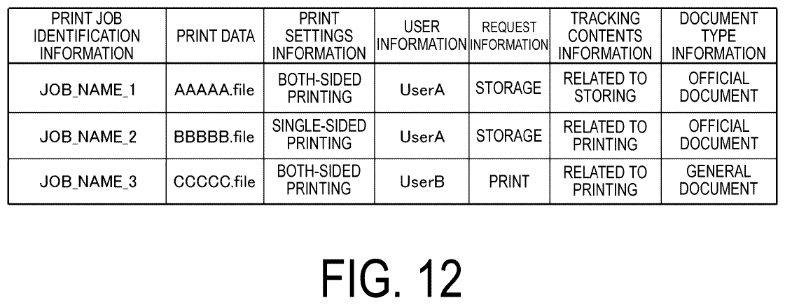

A second embodiment will be described with reference to FIG. 12 to FIG. 17. In the drawings, the same or equivalent elements are denoted by the same reference signs, and redundant descriptions will be omitted. Configurations and processing having substantially the same functions as those in the other embodiments will be referred to by using the same reference characters, descriptions thereof will be omitted, and points differing from the other embodiments will be described.

The controller 409 according to the present embodiment sets tracking information selected based on a type to which print data belongs and the authority of a user who has performed an operation related to storing a print job. Furthermore, when execution of storing a print job for print data belonging to a designated type is selected by an operation of a user having a designated authority, the controller 409 according to the present embodiment limits the execution to storing the print job. In addition, when the execution of storing the print job for the print data belonging to the designated type is not selected by the operation of the user having the designated authority, the controller 409 according to the present embodiment does not limit the execution to storing the print job.

FIG. 12 is a diagram illustrating one example of print jobs according to the present embodiment. The print job exemplified in FIG. 12 and the print job exemplified in FIG. 2 are different from each other in that the print job exemplified in FIG. 12 includes document type information. The document type information indicates a type of print data. For example, the document type information indicates an official document or a general document. The official document refers to a document that certifies the authenticity of contents described therein, and the document that certifies the authenticity of contents described therein is a kind of document to be utilized inside or outside an organization to which a user belongs, and refers to an official document approved by a plurality of supervisors as necessary with respect to the document created by the user. The general document refers to an informal document (that is another document different from the document that certifies the authenticity of contents described therein and that is not an official document).

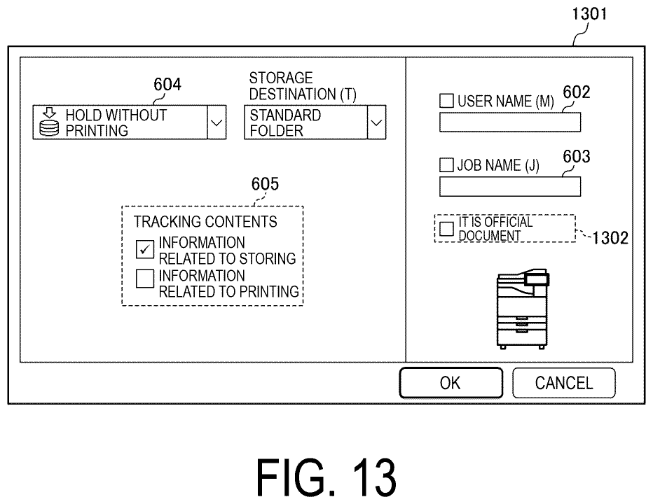

FIG. 13 is a diagram illustrating one example of a print settings screen 1301. The print settings screen 1301 exemplified in FIG. 13 and the print settings screen 601 exemplified in FIG. 6 are different from each other in that the print settings screen 1301 includes a settings area 1302 for official document.

The settings area 1302 is an area where an operation of setting the document type information is to be performed. For example, when the operation unit 403 receives an operation of selecting a check box indicating “official document” included in the settings area 1302, the terminal controller 305 adds document type information indicating an official document to the print job to be set on the print settings screen 1301.

On the other hand, when the operation unit 403 does not receive the operation of selecting the check box indicating “official document” included in the settings area 1302 exemplified in FIG. 13, the terminal controller 305 adds document type information indicating a general document to the print job to be set on the print settings screen 1301.

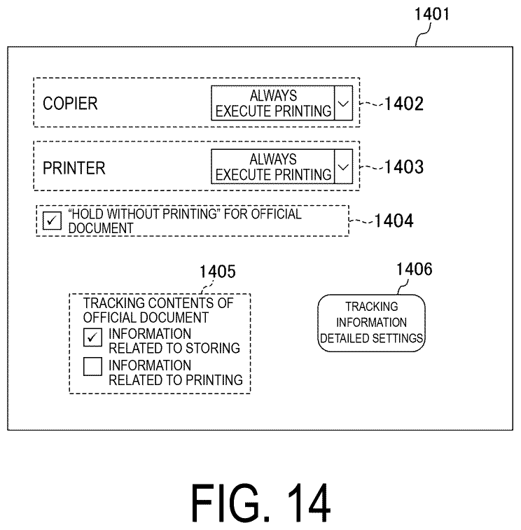

FIG. 14 is a diagram illustrating an example of a system settings screen 1401 according to the present embodiment. The system settings screen 1401 is displayed on the display 304 or the display 404. For example, when a user having the designated authority is successfully authenticated, the terminal controller 305 causes the display 304 to display the system settings screen 1401. Alternatively, when the controller 409 successfully authenticates the user having the designated authority, the controller 409 may cause the display 404 to display the system settings screen 1401. For example, the designated authority is the authority of the administrator of the image forming apparatus 101.

The system settings screen 1401 includes settings areas 1402 to 1405 and a setting button 1406. The settings area 1402 is an area in which, when the acquisition unit 408 acquires print data by reading a document placed on the document table, an operation of setting whether the controller 409 executes storing the acquired print data is to be performed. The settings area 1403 is an area in which, for a print job transmitted by the terminal device 102, an operation of setting whether the controller 409 executes storing the print data added to the print job is to be performed.

The settings area 1404 is an area in which, when document type information indicating an official document is added to the print job, an operation of setting whether the controller 409 executes storing the print data added to the print job is to be performed. The settings area 1404 exemplified in FIG. 14 indicates that when the document type information indicating the official document is added to the print job, the controller 409 stores the print data added to the print job. Thus, the image forming apparatus 101 according to the present embodiment can limit users who can print print data as an official document by setting the print data as the official document not to be printed but to be stored by the operation of the user having the designated authority.

The settings area 1405 is an area where an operation of selecting contents of tracking information about an official document is to be performed. For example, when an authorized signature needs to be added to an official document, it is preferable that contents related to storing be selected as the contents of the tracking information about the official document. Thus, the image forming apparatus 101 can add, to an image based on print data indicating the official document, an image indicating date and time information indicating when the print data indicating the official document has been stored in the storage 402, user information indicating a user who has performed an operation for storing the print data indicating the official document in the storage 402, and the like, and then print the images.

In addition, for example, when information leakage of official documents needs to be suppressed, it is preferable that the contents related to printing are selected as the contents of the tracking information about the official document. Thus, the image forming apparatus 101 can print the image, which is added to the image based on the print data indicating the official document, indicating the time point at which the image based on the print data indicating the official document has been printed, the user who has performed the operation of printing the image based on the print data indicating the official document, and the like.

In addition, for example, as the contents of the tracking information about the official document, the contents related to storing and the contents related to printing may be selected. Accordingly, the image forming apparatus 101 can print the image indicating the contents related to storing and the image indicating the contents related to printing on the image based on the print data indicating the official document.

For example, the settings area 1405 exemplified in FIG. 14 indicates that, when the document type information indicating the official document is added to the print job, the tracking contents information indicating the contents related to storing of the print job is added to the print job. Thus, when the image forming apparatus 101 prints the official document, the printing system 100 according to the present embodiment can add the image based on the tracking information indicating the contents set by the operation of the user having the designated authority to the image based on the print data and then print the images. That is, the printing system 100 according to the present embodiment can cause the user having the designated authority to select contents of tracking information for official documents.

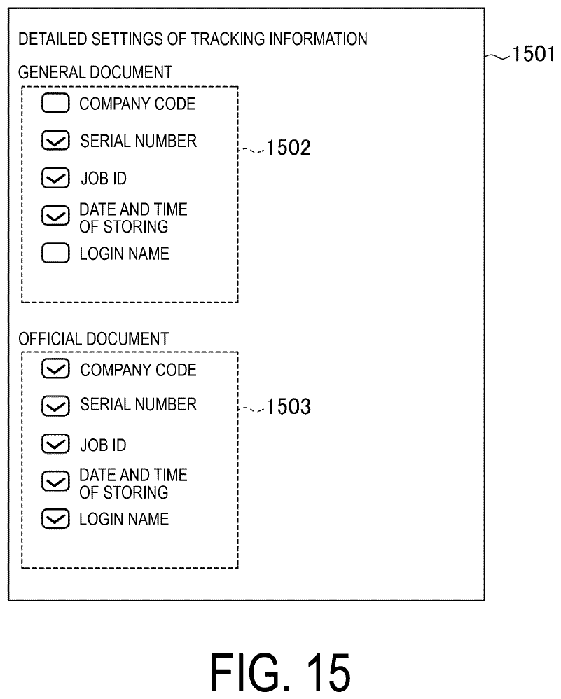

An operation of selecting the setting button 1406 is an operation of displaying the detailed settings screen 1501 (see FIG. 15) for the tracking information.

FIG. 15 is a diagram illustrating one example of a detailed settings screen 1501 for tracking information. The detailed settings screen 1501 includes a settings area 1502 for setting items included in the tracking information for the general document and a settings area 1503 for setting items included in the tracking information for the official document.

When the contents of the tracking information are selected from a plurality of contents included in the settings area 1502 by an operation of the user having the designated authority, the selected contents are stored in the storage 402 in association with the document type information indicating the general document. Specifically, the storage 402 stores the document type information indicating the general document in association with the contents selected from the plurality of contents indicated in the settings area 1502 as the tracking contents information. For example, the settings area 1502 indicates that, for the general document, the tracking information includes a serial number, a job ID, and a date and time of storing.

Moreover, when contents are selected from a plurality of contents included in the settings area 1503 by an operation of the user having the designated authority, the selected contents are stored in the storage 402 in association with the document type information indicating the official document. Specifically, the storage 402 stores the document type information indicating the official document in association with the contents selected from the plurality of contents included in the settings area 1503 as the tracking contents information. The settings area 1503 indicates that, for the official document, the tracking information includes a company code, a serial number, a job ID, a date and time of storing, and a login name.

Thus, as exemplified in FIG. 15, since the tracking information selected by the operation of the user according to the type to which the print data belongs can be selected, the tracking contents information indicating the contents selected according to the type to which the print data belongs are added to the print job in the printing system 100 according to the present embodiment.

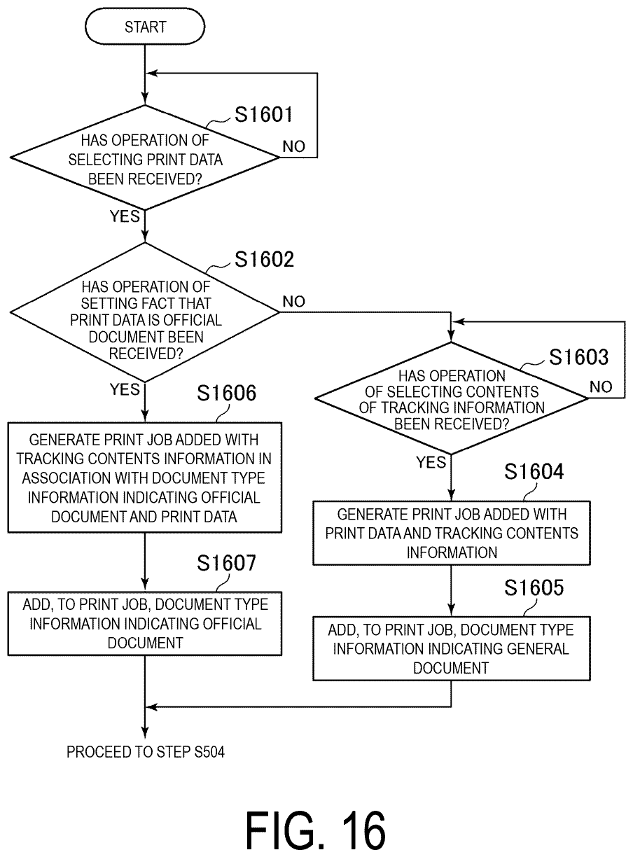

FIG. 16 is a flowchart illustrating one example of an operation of the terminal device 102 according to the present embodiment. The process of step S1601 is similar to the process of step S501 exemplified in FIG. 5, and thus, detailed description thereof will be omitted. It is assumed that when the terminal controller 305 executes the process of step S1601, the document type information indicating the official document is stored in association with the tracking contents information in the storage 302.

In step S1601, when it is determined that the terminal operation unit 303 has received an operation of selecting print data (YES in step S1601), the terminal controller 305 determines, in step S1602, whether the terminal operation unit 303 has received the operation indicating that the selected print data is an official document. For example, when it is determined that the terminal operation unit 303 has received an operation of selecting a check box of “official document” included in the settings area 1302 on the print settings screen 1301, the terminal controller 305 determines that the terminal operation unit 303 has received the operation indicating that the selected print data is the official document. On the other hand, when it is determined that the operation of selecting the check box of “official document” included in the settings area 1302 on the print settings screen 1301 has not been received, the terminal controller 305 does not determine that the terminal operation unit 303 has received the operation indicating that the selected print data is the official document.

When it is not determined in step S1602 that the terminal operation unit 303 has received the operation indicating that the selected print data is the official document (NO in step S1602), the terminal controller 305 shifts the processing to step S1603. The processes of step S1603 to step S1604 are similar to the processes of step S502 to step S503 exemplified in FIG. 5, and thus, detailed description thereof will be omitted.

In step S1605, the terminal controller 305 adds document type information indicating a general document to the print job generated in step S1604. Then, the terminal controller 305 proceeds the processing to step S504 exemplified in FIG. 5.

On the other hand, when it is determined in step S1602 that the terminal operation unit 303 has received the operation indicating that the selected print data is the official document (YES in step S1602), in step S1606, the terminal controller 305 generates a print job added with tracking contents information associated with document type information indicating the official document and the print data.

In step S1607, the terminal controller 305 adds the document type information indicating the official document to the generated print job. Then, the terminal controller 305 proceeds the processing to step S504 exemplified in FIG. 5.

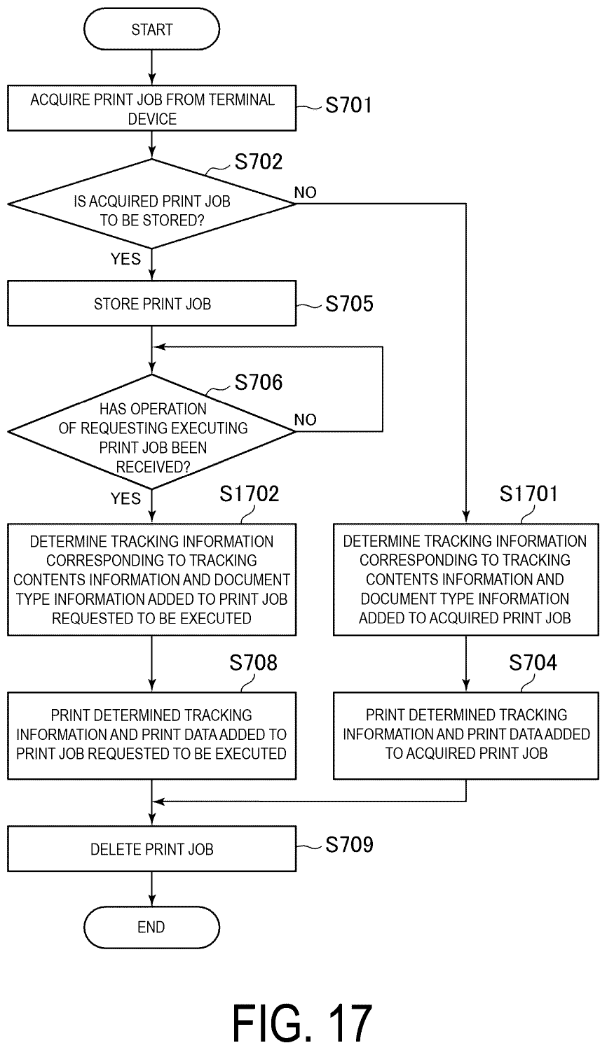

FIG. 17 is a flowchart illustrating one example of an operation of the image forming apparatus 101 according to the present embodiment. The processes of step S701 to step S702 exemplified in FIG. 17 are similar to the processes of step S701 to step S702 exemplified in FIG. 7, and thus, detailed description thereof will be omitted.

When it is determined in step S702 that the print job is not to be stored (NO in step S702), in step S1701, the controller 409 determines tracking information corresponding to the tracking contents information added to the print job and the document type information added to the print job, and adds the determined tracking information to the print job. The tracking information determined in step S1701 and the tracking information determined in step S703 exemplified in FIG. 7 are different from each other in that the tracking information determined in step S1701 includes contents set in advance for the document type information added to the print job. For example, the tracking information determined in step S1701 includes contents set according to the document type information added to the print job on the detailed settings screen 1501. Then, the controller 409 proceeds the processing to step S704. The processes of step S704 and the subsequent step are similar to the processes of step S704 and the subsequent step exemplified in FIG. 7, and thus, detailed description thereof will be omitted.

On the other hand, when it is determined that the print job is to be stored in step S702 (YES in step S702), the controller 409 proceeds the processing to step S705 to step S706. The processes of step S705 to step S706 are similar to the processes of step S705 to step S706 exemplified in FIG. 7, and thus detailed description thereof will be omitted.

When it is determined in step S706 that the operation unit 403 has received an operation of requesting executing the print job (YES in step S706), the controller 409 determines tracking information corresponding to the tracking contents information added to the print job requested to be executed and the document type information added to the print job and adds the determined tracking information to the print job in step S1702. The tracking information determined in step S1702 and the tracking information determined in step S707 exemplified in FIG. 7 are different from each other in that the tracking information determined in step S1702 includes contents set in advance for the document type information added to the print job. For example, the tracking information determined in step S1702 includes contents set according to the document type information added to the print job on the detailed settings screen 1501. Then, the controller 409 proceeds the processing to step S708. The processes of step S708 and the subsequent step are similar to the processes of step S708 and the subsequent step exemplified in FIG. 7, and thus, detailed description thereof will be omitted.

As described above, when the print data transmitted from the terminal device 102 is printed, the image forming apparatus 101 according to the present embodiment can add, to the print data, an image based on the tracking information corresponding to the designated tracking contents information and the designated document type information and then, execute printing.

### Modification

As a modification of the printing system 100 according to the present embodiment, the image forming apparatus 101 may set, by an operation of a user, the fact that the acquired print data is an official document. In the image forming apparatus 103 according to the present modification, the operation unit 403 may receive the operation indicating that the print data acquired by the acquisition unit 408 is an official document.

For example, when the acquisition unit 408 reads a document placed on the document table and acquires print data indicating the read document, the operation unit 403 may receive an operation indicating that the print data acquired by the acquisition unit 408 is an official document. Alternatively, for example, when the acquisition unit 408 acquires print data by loading the print data stored in an external recording medium, the operation unit 403 may receive an operation indicating that the print data acquired by the acquisition unit 408 is an official document.

When it is determined that the operation unit 403 has received the operation indicating that the print data acquired by the acquisition unit 408 is an official document, the controller 409 adds document type information indicating that the print data is an official document to the print job added with the acquired print data. Then, the controller 409 determines tracking information corresponding to the tracking contents information and the document type information added to the print job, and adds the determined tracking information to the print job.

On the other hand, when it is not determined that the operation unit 403 has received an operation indicating that the print data acquired by the acquisition unit 408 is an official document, the controller 409 adds document type information indicating that the print data is a general document to the print job added with the acquired print data.

As described above, when print data generated by reading a document and print data acquired by being loaded from an external recording medium are printed, the printing system 100 according to the present modification can add, to the print data, an image based on the tracking information corresponding to the selected contents and the designated document type and then execute printing.

### Third Embodiment

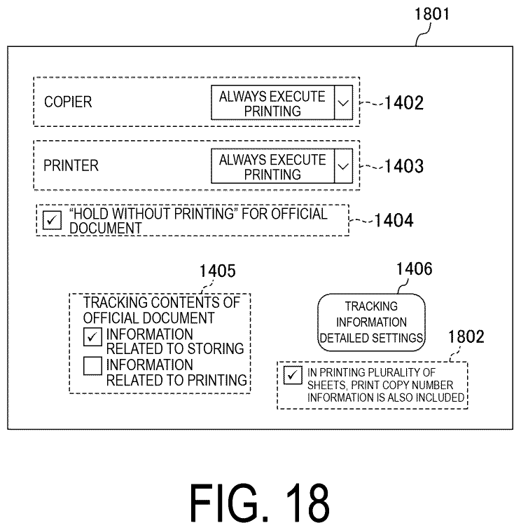

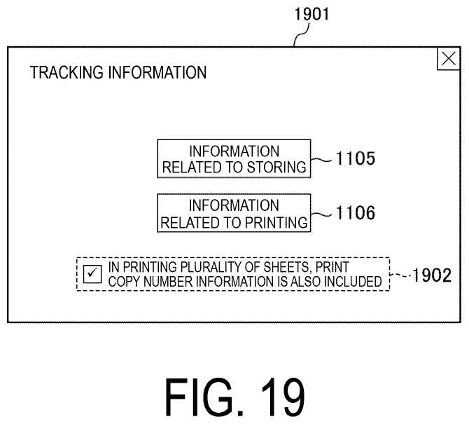

A third embodiment will be described with reference to FIG. 18 to FIG. 19. In the drawings, the same or equivalent elements are denoted by the same reference signs, and redundant descriptions will be omitted. Configurations and processing having substantially the same functions as those in the other embodiments will be referred to by using the same reference characters, descriptions thereof will be omitted, and points differing from the other embodiments will be described.

FIG. 18 is a diagram illustrating an example of a system settings screen 1801 according to the present embodiment. The system settings screen 1801 exemplified in FIG. 18 is different from the system settings screen 1401 exemplified in FIG. 14 in that the system settings screen 1801 includes a settings area 1802 related to the number of print copies.

For example, when the user having the designated authority is the user of the terminal device 102, the terminal controller 305 causes the display 304 to display the system settings screen 1801. Alternatively, when the controller 409 successfully authenticates the user having the designated authority, the system settings screen 1801 is displayed on the display 404.

The settings area 1802 is an area in which an operation of setting whether the tracking information includes print copy number information is to be performed. For example, when the terminal operation unit 303 receives an operation of selecting a setting of “include print copy number information in printing a plurality of sheets” included in the settings area 1802, the tracking information determined by the controller 409 includes the print copy number information.

FIG. 19 is a diagram illustrating one example of a tracking contents selection screen 1901. The tracking contents selection screen 1901 exemplified in FIG. 19 and the tracking contents selection screen 1104 exemplified in FIG. 11 are different from each other in that the tracking contents selection screen 1901 includes a settings area 1902 related to the number of print copies.

For example, when the operation unit 403 receives an operation of displaying the tracking contents selection screen 1901 on the print settings screen 1101 exemplified in FIG. 11, the controller 409 causes the display 404 to display the tracking contents selection screen 1901.

The settings area 1902 is an area in which an operation of setting whether the tracking information includes the print copy number information is to be performed. For example, when the terminal operation unit 303 receives an operation of selecting a check box of “include print copy number information in printing a plurality of sheets” included in the settings area 1902, the tracking information determined by the controller 409 includes the print copy number information. Thus, the image forming apparatus 101 according to the present embodiment adds the tracking information including information indicating the number of print copies and then, executes printing when a plurality of sheets are printed at a time for one piece of print data stored in the storage 402. As described above, the image forming apparatus 101 according to the present embodiment can add tracking information including information indicating that a plurality of sheets have been printed at a time for one piece of print data and then, execute printing.

### Modification

As a modification of the printing system 100 according to the present embodiment, when the terminal operation unit 303 receives an operation of selecting print data, the terminal device 102 may be capable of setting, by an operation of a user, whether tracking information includes print copy number information. Furthermore, in the printing system 100 according to the present modification, when the operation unit 403 receives an operation of selecting print data, the image forming apparatus 101 may be capable of setting, by an operation of a user, whether tracking information includes print copy number information. As a result, the printing system 100 according to the present modification can cause a user to select whether tracking information includes print copy number information when causing the user to select print data.

Each of the processes executed in the embodiments described above is not limited to the processing aspect exemplified in each of the embodiments. The functional blocks described above may be each achieved by using a logic circuit (hardware) formed in an integrated circuit or the like, or by using software using a CPU. Each process described in the embodiments described above may be executed by a plurality of computers. For example, the processing executed by the individual functional blocks of the image forming apparatus 101 and the terminal device 102 may be executed such that a part of the processing is executed by another computer, or may be configured such that all the processing is executed by a plurality of computers in a distributed manner.

The disclosure is not limited to the embodiments described above, and may be replaced with a configuration that is substantially the same as the configuration illustrated in the embodiments described above, a configuration that achieves the same operations and effects, or a configuration that can achieve the same object. As for the disclosure, an embodiment obtained by appropriately combining technical means disclosed in the different embodiments is also included in the technical scope of the disclosure. Furthermore, by combining technical means disclosed in the individual embodiments, it is possible to form a new technical feature.

What is claimed is:

1. An image forming apparatus comprising:
an acquisition unit that acquires print data; and
one or more controllers that execute storing a print job added with the print data, wherein the one or more controller execute adding, to an image based on the print data, an image based on tracking information selected by an operation of a user from tracking information related to the storing of the print job and tracking information related to executing the print job and then executes printing the images.

2. The image forming apparatus according to claim 1, further comprising:
an operation unit that receives the operation of the user.

3. The image forming apparatus according to claim 1,
wherein the one or more controllers set the tracking information selected by the operation of the user according to a type to which the print data belongs.

4. The image forming apparatus according to claim 1,
wherein, regarding the print data belonging to a designated type, the one or more controllers limit the execution to storing the print job when the execution of storing the print job is selected by an operation of a user having a designated authority, and does not limit the execution to storing the print job when the execution of storing the print job is not selected by the operation of the user having the designated authority.

5. The image forming apparatus according to claim 1,
wherein the tracking information selected by the operation of the user is stored for each of a plurality of the users.

6. The image forming apparatus according to claim 1,
wherein when the print job is executed again, the one or more controllers execute adding the image based on the tracking information selected last time by the operation of the user to the image based on the print data and then executes printing the images.

7. The image forming apparatus according to claim 1,
wherein the tracking information related to the storing indicates at least one of a person who requests the storing and a requested date and time of the storing, and
the tracking information related to the executing indicates at least one of a person who requests the printing and a requested date and time of the printing.

8. The image forming apparatus according to claim 1,
wherein the tracking information includes information indicating the number of print copies.

9. An image forming method comprising:
acquiring print data;
storing a print job added with the print data; and
adding, to an image based on the print data, an image based on tracking information selected by an operation of a user from tracking information related to the storing of the print job and tracking information related to executing the print job, and then printing the images.

10. A computer-readable recording medium that records a program, the program causing a computer to execute:
adding, to a print job, print data and tracking information selected by an operation of a user from tracking information related to storing the print job and tracking information related to executing the print job; and
transmitting the print job to an image forming apparatus.
